(19) United States
(12) Patent Application Publication
(10) Pub. No.: US 2008/0047992 A1
(43) Pub. Date: Feb. 28, 2008

(54) Vehicle seat-mounted bow holder

(76) Inventor: Benjamin Wade Fabian, Allen, TX (US)

Correspondence Address: BENJAMIN WADE FABIAN, 913 BLACKSTONE DRIVE, ALLEN, TX, 75002, US

(21) Appl. No.: 11/894,845

(22) Filed: Aug. 22, 2007

Related U.S. Application Data
(60) Provisional application No. 60/839,529, filed on Aug. 23, 2006.

(51) Int. Cl. B60R 7/00

(52) U.S. Cl. 224/275; 29/428

(57) ABSTRACT

A vehicle seat-mounted bow holder and method for stowing and transporting the same. Preferred embodiments include a strap embodiment that is attached by way of a strap to the shoulder or headrest of a vehicle seat, a cap embodiment that is attached by way of a cap to the headrest of a vehicle seat, a band embodiment that is attached by way of a band or straps wrapped around a vehicle seat.

This application claims priority to U.S. Provisional Patent Application 60/839,529 entitled “Vehicle Seat-Mounted Bow Holder” by Benjamin W. Fabian, filed Aug. 23, 2006, is incorporated herein by reference.

### TECHNICAL FIELD

The present invention is directed, in general, to automobile accessories, more specifically to an automotive accessory for stowing and transporting bows secured to the backrest or headrest of a vehicle seat.

### BACKGROUND

Bow users travel with their archery equipment and require a means to transport and store their bow and related archery equipment with them in a vehicle cab. The bow, quiver, and arrows are typically stored on the vehicle seats or floor. When stored in this manner, the archery equipment and vehicle is subjected to possible damage, and this method is unsafe for the user, passengers, and pets.

Bow owners typically carry archery equipment in metal or plastic cases; generally the bow, quiver, and arrows contained in separate cases. This approach has many disadvantages: it consumes vehicle interior space, it increases the time to remove and/or stow archery equipment, and it requires the user to assemble and/or disassemble their bow for each use.

Numerous prior attempts have been made to transport and store personal items, firearms, and the like in a vehicle, most attempts have focused on transport and storing of personal items and guns rather than bows. Recognizing the problems associated with current bow transport and storing methods, there is substantial opportunity to provide a means of transport and storage for bows on a vehicle seat.

An example of prior art to provide transport and storing of umbrellas in a vehicle is provided in U.S. Pat. No. 959,072 entitled “Umbrella Holder” to Reithmiller, issued May 24, 1910, which is incorporated herein by reference. Reithmiller's invention is limited in that it must be permanently fixed to the vehicle seat back using means that damage the upholstery.

An example of prior art to provide transport and storing of firearms and the like in a vehicle is provided in U.S. Pat. No. 2,535,564 entitled “An Automobile Supporting Rack for Firearms and the Like” to Campbell, issued Dec. 26, 1950, which is incorporated herein by reference. Campbell's invention is limited in that the rigid hook portions that fit over the top of the seat interfere with the use of the seat and in that rigid hook members are used to support each gun. The invention is further limited in that it is not capable of accommodating a bow vertically.

An example of prior art to provide transport and storing of guns is provided in U.S. Pat. No. 2,577,713 entitled “Portable Gun Rack” to Nogle, issued Dec. 4, 1951, which is incorporated herein by reference. Nogle's invention is limited in that it is not capable of accommodating a bow.

An example of prior art to provide transport and storing of guns in a vehicle is provided in U.S. Pat. No. 2,797,033 entitled “Portable Knock-Down Gun Rack” to Rasbach, issued Jun. 25, 1957, which is incorporated herein by reference. Rasbach's invention is limited in that the rigid grip portions that fit over the top of the seat interfere with the use of the seat. The invention is further limited in that it is not capable of accommodating a bow.

An example of prior art to provide transport and storing of umbrellas in a vehicle is provided in U.S. Pat. No. 2,853,219 entitled “Umbrella Containers for Automobiles” to Schwartz, issued Sep. 23, 1958, which is incorporated herein by reference. Schwartz' invention is limited in that the rigid hooks that fit over the top of the seat interfere with the use of the seat. The invention is further limited in that it is not capable of securing a bow.

An example of prior art to provide transport and storing of personal items in a vehicle is provided in U.S. Pat. No. 3,014,759 entitled “Automotive Utility Bag” to Bing, issued Dec. 26, 1961, which is incorporated herein by reference. Bing's invention is limited in that it is not capable of accommodating a bow.

An example of prior art to provide transport and storing of gun in a vehicle is provided in U.S. Pat. No. 3,167,182 entitled “Gun Rack and Method of Manufacture Thereof” to Calvin, issued Jan. 26, 1965, which is incorporated herein by reference. Calvin's invention is limited in that either it must be permanently fixed to the vehicle seat back using means that damage the upholstery or in that the rigid hooked upper ends that fit over the top of the seat interfere with the use of the seat. The invention is further limited in that it is not capable of accommodating a bow.

An example of prior art to provide transport and storing of an umbrella in a vehicle is provided in U.S. Pat. No. 3,526,238 entitled “Safety Zipboot and Umbrella” to Brayton, issued Sep. 1, 1970, which is incorporated herein by reference. Brayton's invention is limited in that it must be permanently fixed to a vehicle seat back damaging the upholstery. The invention is further limited in that it is not capable of accommodating a bow.

An example of prior art to provide transport and storing of a gun in a vehicle is provided in U.S. Pat. No. 4,995,537 entitled “Removable Gun Rack” to Thedieck, issued Feb. 26, 1991, which is incorporated herein by reference. Thedieck's invention is limited in that it is not capable of carrying a bow.

An example of prior art to provide storing of personal items is provided in U.S. Pat. No. 5,027,960 entitled “Hanger Strap” to Rainville, issued Jul. 2, 1991, which is incorporated herein by reference. Rainville's invention is limited in that it is not capable of accommodating a bow in a vehicle.

An example of prior art to provide transport of a bow is provided in U.S. Pat. No. 5,065,732 entitled “Bow Sling” to Smith, issued Nov. 19, 1991, which is incorporated herein by reference. Smith's invention is limited in that it is not capable of securing a bow onto a vehicle seat.

An example of prior art to provide transport and storing of personal items is provided in U.S. Pat. No. 5,226,576 entitled “Vehicle Trash Container” to Ellsworth, issued Jul. 13, 1993, which is incorporated herein by reference. Ellsworth's invention is limited in that it is not capable of accommodating a bow.

An example of prior art to provide transport and storing of guns is provided in U.S. Pat. No. 5,443,191 entitled “Portable Vehicle-Mounted Gun Rack” to Jorgenson, issued Aug. 22, 1995, which is incorporated herein by reference. Jorgenson's invention is limited in that it is not capable of accommodating a bow.

An example of prior art to provide transport and storing of personal items is provided in U.S. Pat. No. 5,490,623 entitled “Utility Bag” to McConnell, issued Feb. 13, 1996, which is incorporated herein by reference. McConnell's invention is limited in that it is not capable of accommodating a bow.

An example of prior art to provide transport and storing of guns is provided in U.S. Pat. No. 5,495,969 entitled “Recreational Vehicle Portable Gun Rack System” to Cardenas, issued Mar. 5, 1996, which is incorporated herein by reference. Cardenas' invention is limited in that it is not capable of securing a bow and requires use of the entire back seat of a vehicle.

An example of prior art to provide transport of a bow is provided in U.S. Pat. No. 5,513,621 entitled “Protective Device for Hunting Bows” to Vanskiver issued May 7, 1996, which is incorporated herein by reference. Vanskiver's invention is limited in that it is not capable of securing a bow onto a vehicle seat.

An example of prior art to provide transport of a bow is provided in U.S. Pat. No. 5,730,641 entitled “Sling Assembly for a Compound Bow” to Hester Jr., issued Mar. 24, 1998, which is incorporated herein by reference. Hester Jr. invention is limited in that it is not capable of securing a bow on a vehicle seat and requires modification of the bow.

An example of prior art to provide transport and storing of a bow is provided in U.S. Pat. No. 6,155,470 entitled “ATV/Backpack-Mounted Bow Carrier” to Robison, issued Dec. 5, 2000, which is incorporated herein by reference. Robinson's invention is limited in that it cannot be mounted onto a vehicle seat since it requires the use of a rack to mount onto a vehicle and requires the back seat passenger space of a vehicle.

An example of prior art to provide transport and storing of guns is provided in U.S. Pat. No. 6,279,799 entitled “Portable Detachable Combination Gun Case and Gun Rack for a Vehicle” to Horton, issued Aug. 28, 2001, which is incorporated herein by reference. Horton's invention is limited in that it is not capable of accommodating a bow.

An example of prior art to provide transport and storing of guns is provided in U.S. Pat. No. 6,405,909 entitled “Seat-Mounted Gun and Rod Holder” to Burnett, issued Jun. 18, 2002, which is incorporated herein by reference. Burnett's invention is limited in that it is not capable of accommodating a bow. The invention is further limited in that the invention requires both the driver and the passenger side vehicle seat backrest.

Thus there would thus be substantial benefit in a bow holder which is seat-mounted, has a vertical compartment, allows access from either side of a vehicle, does not damage interior surfaces of a vehicle, protects a bow and attached accessories from damage, does not require modification to the bow, allows for orderly carrying of a bow and archery equipment, and does not require permanent attachment to the seat or any other part of the vehicle.

### SUMMARY OF THE INVENTION

The invention is a seat-mounted bow holder that mounts onto a vehicle seat. Preferred embodiments of the invention comprises of a holder, the holder top attached to the upper portions of a vehicle seat by straps, bands, or caps, and is restrained at the holder bottom at points of fastening. The weight of the holder is borne either by straps, caps or bands, depending on the seat design.

In the case of strap embodiment, straps attach to the holder top. The straps encircle and fasten around the tapered shoulders or headrest of the seat. On seats with adjustable headrests, the straps encircle and fasten around the metal headrest support posts.

In the case of the band embodiment, a band or straps attach to the holder top. The band or straps wrap around the front of the vehicle seat and under the seat backrest between the seat backrest and seat bottom. The band or straps attach to the seat bottom or holder bottom.

With the cap embodiment, the holder is attached to the cap bottom. The cap covers a portion of the tops of the seat or headrest.

The points of fastening at the holder bottom corners are restrained by straps with the other end of the straps being attached underneath the vehicle seat to a secure point or onto the holder band or straps itself. This feature confines the holders so that they do not swing or bounce when the vehicle moves.

Because the bow holder is suspended on the seats, bow and arrows are kept off the floor and off seating surfaces. In this way, the advantage of organization is realized. Another advantage is that knee room for passengers in the back seat, and headroom for all occupants is not diminished. A further advantage is that the bows, arrows, and archery equipment are securely held by nonabrasive materials, thus, damage to bow surfaces, sights, cams, strings, and other attached accessories is reduced, and a safe and secure method of archery equipment storage and transportation is realized. Yet another advantage is that the bow is suspended from seats, which are cushioned, thus the bow is spared the jolting and jarring they would be subject to if unrestrained or if stored in a rigid rack. Yet another advantage is that various configurations of vehicle seats may be fitted with the invention. Another advantage is that bows can be retrieved from either side of the vehicle, and a multiple of holders may be attached in a single vehicle allowing for stowage of multiples of bows. Another advantage is found in the fact that no permanent holes need to be drilled into the vehicle to accomplish the mounting of the holder. Yet another advantage is that the bow can be rapidly installed or removed from the holder allowing quick retrieval and stowage of bow and archery equipment without bow disassembly. Yet another advantage is that the holder be rapidly installed onto or removed from vehicle seats (e.g., in seconds). This is advantageous to users who want to have the holder in place only for expeditions and to remove it for everyday use of the vehicle. The ease of installation and removal gives them this option. Another advantage is that, in preferred embodiments, the appearance of the bow holder is harmonious with that of the seat, the device being fabricated of sewn fabrics and conforming to the seats natural contours.

A preferred embodiment of the invention is the strap embodiment. This embodiment of the invention has the virtue of universality. The strap embodiment fits the seats of most vehicles in which bow owners usually carry bows. It fits seats with tapered shoulders and seats with adjustable headrests. Moreover, the strap embodiment can be moved from vehicle to vehicle.

A preferred embodiment of the invention is the band embodiment. This embodiment is applicable to bench style seats with a horizontal top. The back plate wraps around the top of the seat backrest, then cascades down the front of the seat, lying between the seat upholstery and the user's body. The band continues under the bottom of the backrest of the seat through to the back. There, points of fastening are employed to secure the band either to the seat bottom, or to the lower corners of the holder, near the position at which the holder is attached to the band.

A preferred embodiment of the invention is the cap embodiment. This embodiment has the virtue in that the shape of the cap can be customized so that the apparatus appears to be integrated into the seat. It has the structural advantage of bearing the weight of the holder on the headrest of the seat, rather than on the sides of the tapered shoulders of the seat, and it distributes the weight over a broader area than the straps of the strap embodiment. In the case of some vehicle seats, use of the cap embodiment is almost imperative, in that the straps of the strap embodiment would slide down the nearly vertical sides of the shoulders of the seat

In the preferred embodiments, conventional fabrication processes are used to manufacture the device. The piece goods are sent to a cutter who cuts the front plate and back plate with a template. The compartment side of the front plate and back plate are combined together by an assembler on the left, bottom, and right sides to form a compartment. Depending on the model, the assembler then attaches either straps or a cap to the back plate top. Next the assembler attaches straps to the left and right side of the back plate. Next the assembler attaches straps to the bottom left and bottom right of the back plate. A securing means, usually a male or female buckle, is installed on all free ends of the straps, in a manner to allow opposite strap ends to secure to each other.

In all embodiments, the strap member securing means on the free ends are a wide variety. Alternatives include any male-female fastening type, D-rings, buckles, eyelet, hook-and-eye, hook-and-loop (Velcro®), clasp, clip, or button, and are made of any material. In all embodiments, a wide variety of materials may be used for the straps. Alternatives include nylon, polypropylene, fabric, rope, shock cord, bungee cord, rubber cord, elastic, or hook-and-loop (Velcro®). In all embodiments, a wide variety of materials may be used for face plates and back plates. Alternatives include leather, denim, hide, vinyl, plastic, cotton, and poly-cotton blends. In alternative embodiments, the holders and compartments are wider or narrower that those shown for the preferred embodiments.

To install the strap embodiment, the user wraps the holder top strap members around the shoulder region of the vehicle seat or headrest or around the headrest posts, fastens the top strap members together while tightening. The user then attaches each bottom strap member to a fastening point at the bottom of the vehicle seat while tightening the strap members.

To install the band embodiment, the user wraps the back plate top strap members around the top of the vehicle seat, then under the vehicle seat backrest to meet the back plate bottom. The user then attaches the bottom strap members to the top strap members to join the back plate top and bottom while tightening. In an alternate embodiment the back plate bottom may be attached to a fastening point at the bottom of the vehicle seat

To install the cap embodiment, the user places the cap over the headrest of the seat. The user then attaches each bottom strap members to a fastening point at the bottom of the vehicle seat.

It is an object of the invention to provide a bow holder, which is easy to install onto and remove from vehicle seats, in which placing and retrieving a bow is simple. It is another object of the invention to provide vertical storage for one or more bows. It is another object of the invention to provide mounting systems appropriate for a variety of vehicle seats. It is another object of the invention to provide bow storage and transport system, which does not necessitate permanent damage to seats and other vehicle surfaces. It is another object of the invention to restrict the bow from jostling out of the bow holder. It is another object of the invention to protect the bow attachments and surfaces. It is another object of the invention to conserve room in vehicle interiors by the orderly placement of bows and archery equipment.

The foregoing has outlined broadly the features and technical advantages of the present invention in order that a detailed description of the invention that follows may be better understood. A person skilled in the art will realize that other embodiments of the invention are possible and that the details of the invention can be modified in a number of respects, all without departing from the spirit and scope of the invention as set forth in the appended claims.

### BRIEF DESCRIPTION OF THE SEVERAL VIEWS OF THE DRAWINGS

For a more complete understanding of the present invention, and the advantages thereof, reference is now made to the following descriptions taken in conjunction with the accompanying drawings, in which:

FIG. 1 Illustrates a pictorial view, in perspective, of the strap embodiment of the invention.

FIG. 2 Illustrates a pictorial view, in perspective, of the band embodiment of the invention.

FIG. 3 Illustrates a pictorial view, in perspective, of the cap embodiment of the invention.

FIG. 4 Illustrates a pictorial view, in perspective, of the application of the strap embodiment of the invention, and represents the application of band and cap embodiments.

FIG. 5 Illustrates a pictorial view, in perspective, of the strap embodiment of the invention when attached around a vehicle seat shoulder or headrest.

FIG. 6 Illustrates a pictorial view, in perspective, of the strap embodiment of the invention when attached to an adjustable headrest vehicle seat.

FIG. 7 Illustrates a pictorial view, in perspective, of the cap embodiment of the invention when attached to a shoulder vehicle seat.

FIG. 8 Illustrates a pictorial view, in perspective, of the band embodiment of the invention when attached to a bench vehicle seat.

### DETAILED DESCRIPTION OF THE ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to mane and use the invention, and do not limit the scope of the invention.

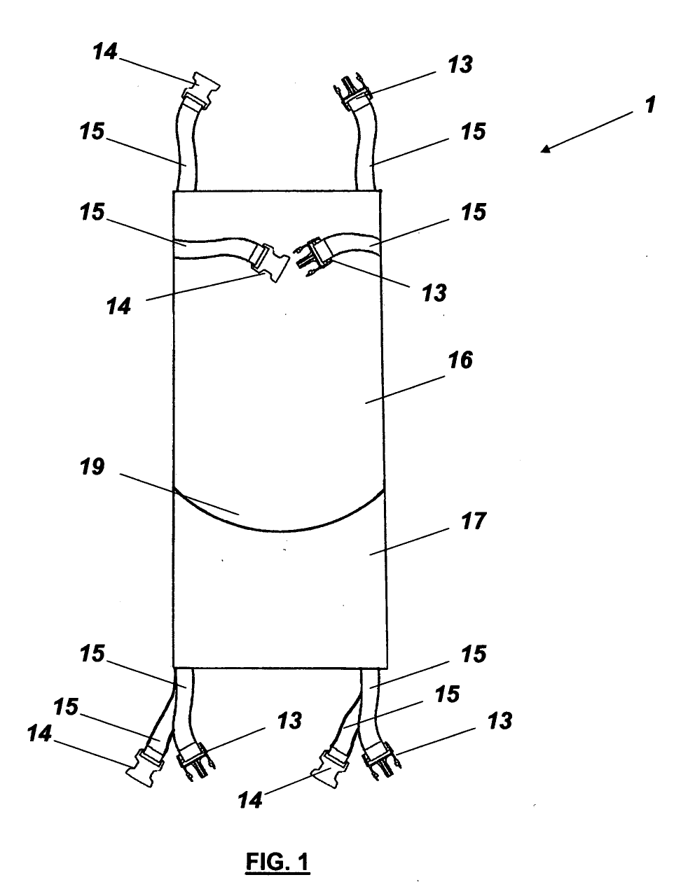

Referring to FIG. 1, a preferred embodiment of the strap embodiment 1 of the invention. Holder comprises a face plate 17 which is attached to a back plate 16. Both face plate 17 compartment side and back plate 16 compartment side are bonded together on the left, bottom, and right sides to form a compartment 19 in which the top of the face plate 17 compartment side is free from the back plate 16 compartment side. A multiple of straps 15 are affixed by one strap 15 end to the back plate 16 on the top left, top right, bottom left, bottom right, mid left, and mid right. These straps 15 are affixed on the opposite end with either a male buckle 13 or female buckle 14 to allow connection from holder right side to holder left side for the top and mid straps 15, and to a fastening point for the bottom straps 15.

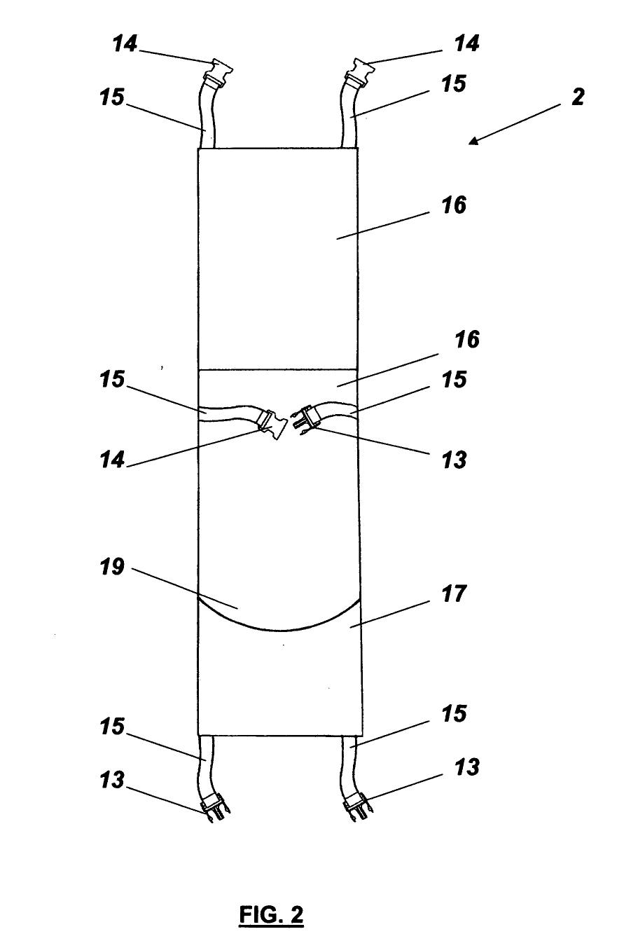

Referring to FIG. 2, a preferred embodiment of the band embodiment 2 of the invention. Holder comprises a face plate 17 which is attached to a back plate 16. Both face plate 17 compartment side and back plate 16 compartment side are bonded together on the left, bottom, and right sides to form a compartment 19 in which the top of the face plate 17 compartment side is free from the back plate 16 compartment side. A multiple of straps 15 are affixed by one strap 15 end to the back plate 16 on the top left, top right, bottom left, bottom right, mid left, and mid right. These straps 15 are affixed on the opposite end with either a male buckle 13 or female buckle 14 to allow connection from holder right side to holder left side for the mid straps 15, and to a fastening point the top and bottom straps 15 or to fasten the top straps 15 to the bottom straps 15.

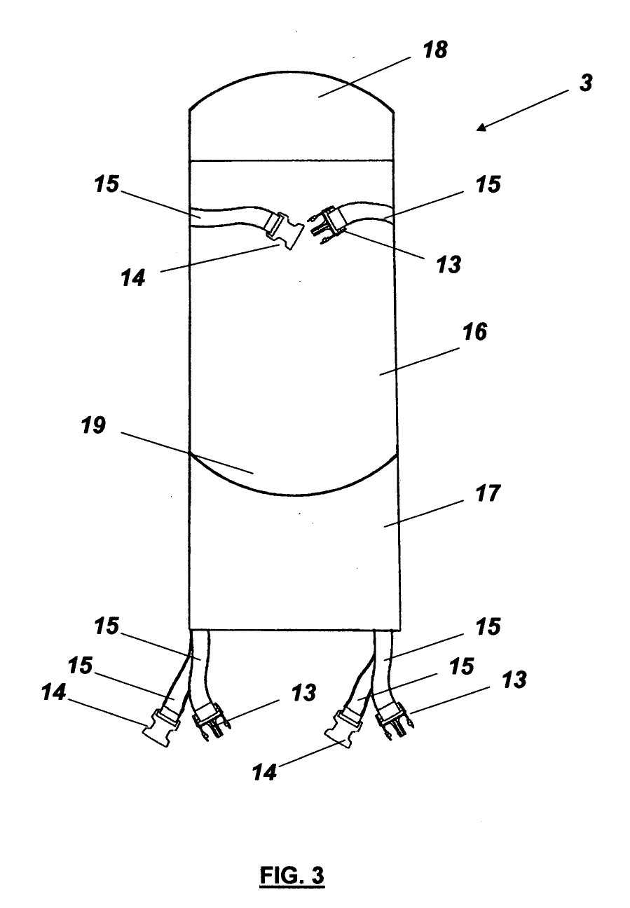

Referring to FIG. 3, a preferred embodiment of the cap embodiment 3 of the invention. Holder comprises a face plate 17 which is attached to a back plate 16. Both face plate 17 compartment side and back plate 16 compartment side are bonded together on the left, bottom, and right sides to form a compartment 19 in which the top of the face plate 17 compartment side is free from the back plate 16 compartment side. The top of the back plate 16 compartment side is bonded onto its exterior side on the left side and right top side to form a cap 18 in which the back plate 16 compartment side is free from its exterior side. A multiple of straps 15 are affixed by one strap 15 end to the back plate 16 on the bottom left, bottom right, mid left, and mid right. These straps 15 are affixed on the opposite end with either a male buckle 13 or female buckle 14 to allow connection from holder right side to holder left side for the mid straps 15, and to a fastening point for the bottom straps 15.

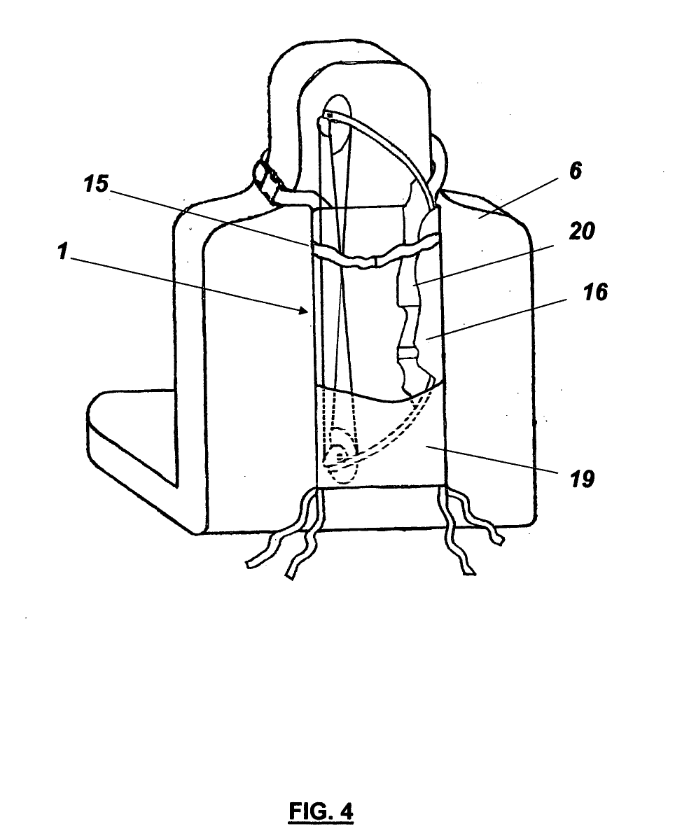

Referring to FIG. 4, a preferred embodiment of the strap embodiment 1 of the invention method for securing bow 20 onto the holder to permit a bow 20 having rest vertically inside the compartment 19 and means for retaining bow 20 to back plate 16 using mid left and mid right straps 15.

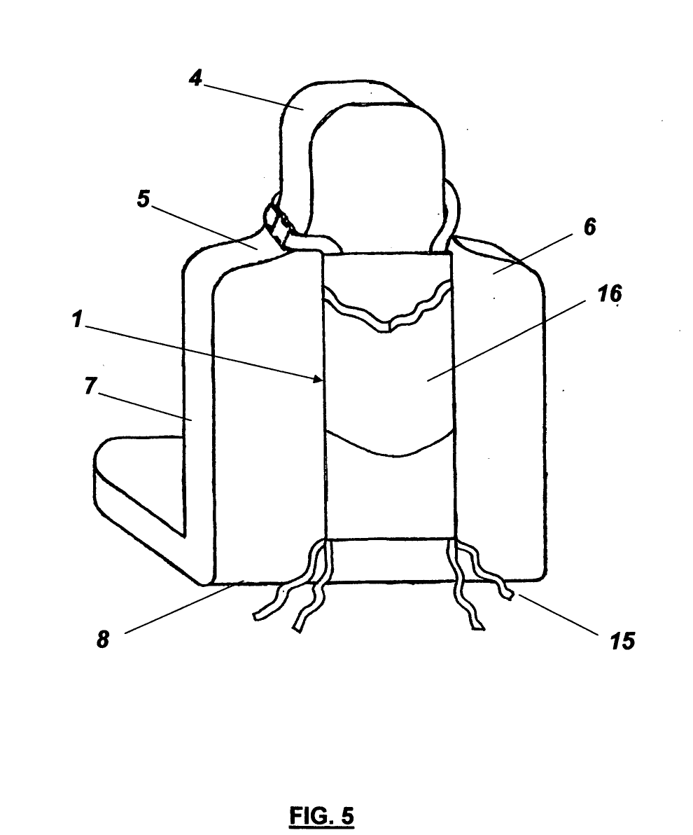

Referring to FIG. 5, a preferred embodiment of the strap embodiment 1 of the invention is installed onto vehicle seat 7 where back plate 16 exterior contacts seat back rest 6. Holder top left and top right straps 15 connect around seat headrest 4 and rests on seat shoulder 5. Holder bottom right side and bottom left side straps 15 secure the holder to a fastening point under the seat bottom 8.

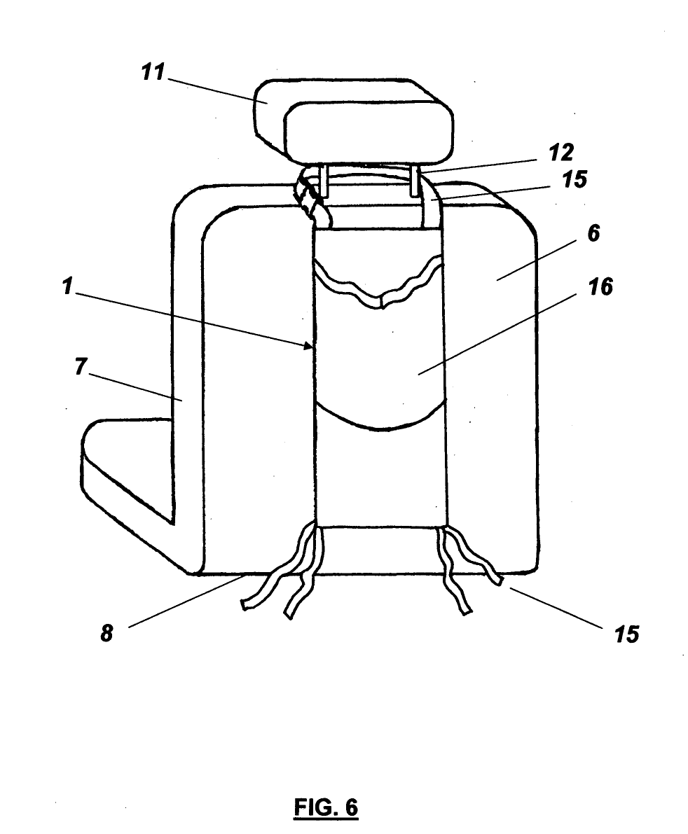

Referring to FIG. 6, a preferred embodiment of the strap embodiment 1 of the invention is installed onto vehicle seat 7 where back plate 16 exterior contacts seat back rest 6. Holder top left and top right straps 15 connect around seat adjustable headrest 11 and rests around seat headrest posts 12. Holder bottom right side and bottom left side straps 15 secure the holder to a fastening point under the seat bottom 8.

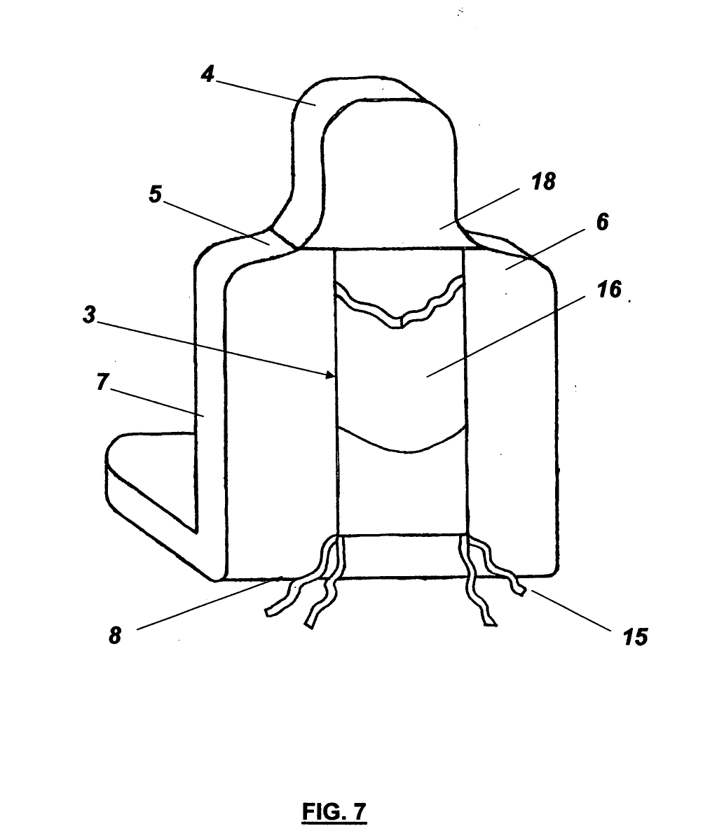

Referring to FIG. 7, a preferred embodiment of the cap embodiment 3 of the invention is installed onto vehicle seat 7 where back plate 16 exterior contacts seat back rest 6. Holder cap 18 covers seat headrest 4 and rests on seat shoulder 5. Holder bottom right side and bottom left side straps 15 secure the holder to a fastening point under the seat bottom 8.

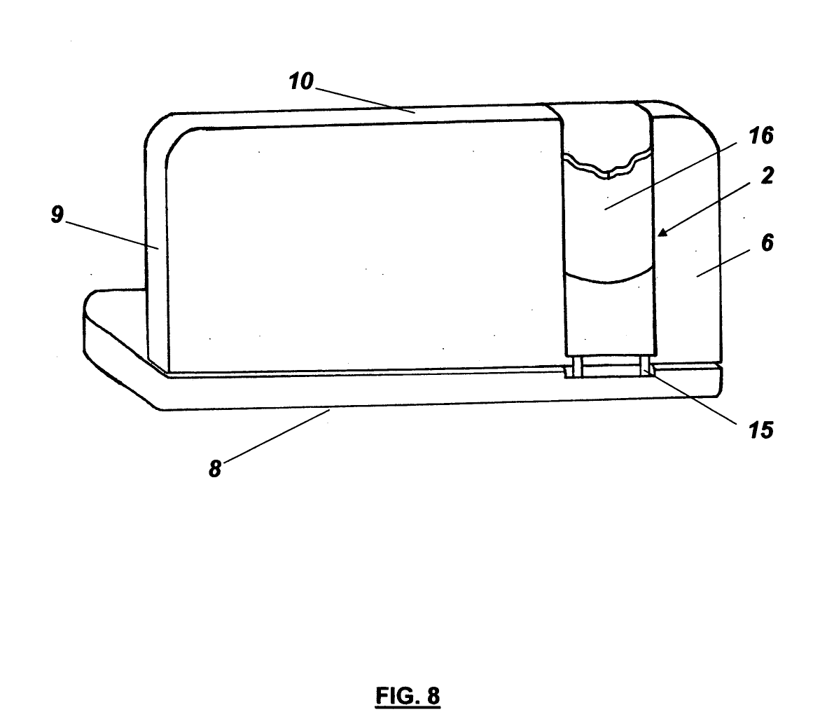

Referring to FIG. 8, a preferred embodiment of the band embodiment 2 of the invention is installed onto vehicle bench seat 9 where back plate 16 exterior contacts seat back rest 6. Holder back plate 16 folds over bench seat top 10 and under seat back rest 6. Holder top left side, top right side, bottom right side, and bottom left side straps 15 secure the holder to a fastening point under the seat bottom 8, or holder top left side, top right side, bottom right side, and bottom left side straps 15 secure the back plate 16 top to the back plate 16 bottom.

Many variations of the invention will occur to those skilled in the art. Some variations attach to seats by vertically-oriented means, such as straps, caps or bands. Other variations call for attachment to seats by horizontally-oriented means, such as girdles. All such variations are intended to be within the scope and spirit of the invention.

What is claimed is:

1. A seat-mounted bow holder comprising: A holder comprises:
a flexible back plate having two upper corners, two lower corners, a left side, a right side, a compartment side, and an exterior side, and
a flexible face plate having a compartment side and an exterior side, said flexible face plate being attached to said flexible back plate to form a compartment having three sides closed and one side open and being sized to permit a bow having rest vertically inside the compartment;
A means for retaining a bow to said back plate; and
A means for fastening each of said upper corners of holder to the top of a vehicle seat; and
A means for fastening each of said lower corners of holder to the bottom of a vehicle seat;
Wherein capable of supporting a bow.

2. The bow holder of claim 1 in which said means for fastening said upper corners of holder to the top of a vehicle seat comprises:
A strap member attached to each said upper left and upper right corners of said back plate, each strap member having a securing means on the free ends, to allow for fastening both strap members together, around the shoulder or headrest of a vehicle seat.

3. The bow holder of claim 1 in which said means for fastening said upper corners of holder to the top of a vehicle seat comprises:
A cap attached to each said upper left and upper right corners of said back plate, that is configured to fit over the shoulder or headrest of the vehicle seat.

4. The bow holder of claim 1 in which said means for fastening said lower corners of holder to the bottom of a vehicle seat comprises:
A strap member attached to each said lower left and lower right corner of said back plate, each strap member having a securing means on the free ends, to allow for fastening both strap members together, around a securing point under the vehicle seat.

5. The bow holder of claim 1 in which said means for fastening said upper corners of holder to the top of a vehicle seat and said bottom corners of holder to the bottom of a vehicle seat comprises:
a strap member attached to each said upper left and upper right corners of said back plate, a strap member attached to each said lower left and lower right corners of said back plate, said back plate or strap members being of sufficient length to wrap around the vertical girth of the vehicle seat, each strap member having a securing means on the free ends, to allow for fastening of upper strap members to lower strap members under the backrest of a vehicle seat.

6. The bow holder of claim 1 in which a protective material layer is bonded to said compartment side or said exterior side of face plate or back plate.

7. The bow holder of claim 1 wherein the compartment is sized to accommodate the end of a bow.

8. The bow holder of claim 1 wherein the means to retain a bow to said back plate comprises:
A strap member attached to each said left side and right side of said back plate, each strap member having a securing means on the free ends, to allow for fastening both strap members together, around a bow.

9. The bow holder of claim 1 in which said holder orientation is attached to either vehicle seat front or vehicle seat back.

10. The bow holder of claim 1 wherein said back plate or front plate are stiffened using a rigid material attached to said back plate or front plate.

11. The bow holder of claim 1 wherein said back plate or front plate are shaped using a rigid material attached to said back plate or front plate

12. A means of securing a bow or a multiple of bows to a vehicle seat using a compartment, pocket, pouch, holder, bands, slings, or straps.

13. A means of fabricating a bow holder comprising:
attaching said face plate to said back plate to form a compartment having three sides closed and one side open and being sized to permit a bow having rest vertically inside the compartment;
attaching a strap member to each said left side and right side of a back plate, each strap member having a securing means on the free ends, to allow for fastening both strap members together, around a bow, to retain a bow to a back plate;
attaching a means for fastening said holder to the top of a vehicle seat to the top of said back plate, wherein attaching means for fastening step is selected from a group consisting of:
attaching a strap member to each said upper left and upper right corners of said back plate, each strap member having a securing means on the free ends, to allow for fastening both strap members together, around the shoulder or headrest of a vehicle seat,
attaching a cap to each said upper left and upper right corners of said back plate, that is configured to fit over the shoulder or headrest of the vehicle seat, and
attaching a strap member to each said upper left and upper right corners of said back plate, said back plate or strap members being of sufficient length to wrap around the vertical girth of the vehicle seat, each strap member having a securing means on the free ends, to allow for fastening of upper strap members to lower strap members, under the backrest of a vehicle seat, and
attaching a means for fastening said holder to the bottom of a vehicle seat to the bottom of said back plate, wherein attaching means for fastening step is consisting of:
attaching a strap member to each said lower left and lower right corners of said back plate, each strap member having a securing means on the free ends, to allow for fastening each strap member to itself, around a securing point under the vehicle seat.
attaching a strap member to each said lower left and lower right corners of said back plate, each strap member having a securing means on the free ends, to allow for fastening of upper strap members to lower strap members, under the backrest of a vehicle seat.
